(19) United States
(12) Patent Application Publication
(10) Pub. No.: US 2005/0056144 A1
(43) Pub. Date: Mar. 17, 2005

(54) Computer music input system, processing method and keyboard apparatus

(76) Inventors: Yue Yang, Redmond, WA (US); Wei Tao, Redmond, WA (US)

Correspondence Address: MERCHANT & GOULD PC, P.O. BOX 2903, MINNEAPOLIS, MN, 55402-0903, US

(21) Appl. No.: 10/891,820

(22) Filed: Jul. 14, 2004

(30) Foreign Application Priority Data
Jul. 18, 2003 (CN) 03150136.2

(51) Int. Cl. A63H 5/00; G10H 7/00; G04B 13/00; G10H 1/32

(52) U.S. Cl. 84/719

(57) ABSTRACT

A computer music input system and the associated signal processing method and input apparatus are provided, wherein the input system comprises a keyboard input apparatus consisting of a music-input device and a character-input device. The keyboard input apparatus generates standard keyboard key code. Music processing software running in the computer generates digital sampling data of the music sound and handles keyboard interrupt events. A computer sound card plays back the music notes.

### FIELD OF THE INVENTION

This invention relates to a computer input system, more particularly, to a digital music input system, method of processing the input signal, and keyboard input apparatus.

### BACKGROUND OF THE INVENTION

With the growing functionality in multimedia computers, especially with the advent of the MIDI (Musical Instrument Digital Interface) interface, computers are playing an increasingly important role in the area of digital music. MIDI is a protocol standard that defines how musical events and note properties are communicated between musical devices, such as synthesizers and sequencers. FIG. 1 is a view showing the typical processing flow of a common MIDI system, wherein component 11 is a special-purpose MIDI input device, such as a MIDI keyboard or a musical keyboard with a MIDI interface. Such a MIDI input device contains special hardware to produce MIDI signals, but it does not generate sound directly. Component 12 is a sequencer, which is used to edit and control MIDI signals. Component 13 is the sound generator that produces the analog signals corresponding to the MIDI signals. After being amplified by a power amplifier 14, the analog signals can be played by a speaker 15. Special-purpose MIDI keyboards are very expensive. In addition, they do not have the capability for character input.

As a standard input device, computer keyboard is a critical component of a computer system. A computer keyboard generally consists of a set of keys and the control circuit, which comprises a matrix of switches. A circuit switch is closed when the corresponding key is pressed. By scanning the switches and detecting the on/off state, the microcontroller inside the keyboard can generate key codes and transfer them to the computer following a standard protocol, such as the AT interface, PS/2, USB, or a wireless mechanism using infra-red (IR) or radio. The motherboard on the computer contains a keyboard controller that communicates with the keyboard. It converts a received key code from the microcontroller inside the keyboard into a system code and stores it into a buffer, and then generates a keyboard interrupt signal. A keyboard interrupt service program retrieves the system code after receiving the interrupt signal, and passes the code to the operating system for further processing with other application.

In contrast to the tremendous advances in other hardware components, computer keyboards still follow their original design, which has not experienced fundamental improvements over the past several decades. Standard keyboards contain 101, 104, or 107 keys. The layout of the keys, adapted from typewriters, typically uses the QWERTY (named after the arrangement of the first six keys in the first row of a standard keyboard) format. Ergonomic keyboards and multimedia keyboards have been developed. The former is to adjust the keyboard shape according to human posture, thereby alleviating the stress on human bodies. The latter adds certain special keys, called short-cut keys, for controlling commonly used computer programs. Since existing computer keyboards are designed for character input, they are not suitable for music input.

In summary, there exist the following three methods for inputting computer music. Unfortunately, each approach has its drawback.

1) The most common approach in today's digital music system is relying on a special-purpose MIDI keyboard to input music to the computer, and using a MIDI-capable sound card to play the music. Although MIDI hardware components provide high-quality sound effects and broad control capabilities, they are very expensive. Because a MIDI keyboard needs to contain the special-purpose hardware for generating MIDI signals, it is often ten times more costly than a standard computer keyboard. In addition, assembling a MIDI system is a complex process for novices. Furthermore, incompatibility may exist among various hardware devices. Therefore, this method is only ideal for a small group of specialists, but not desirable for a broad range of consumers. The high cost and complexity are the primary reasons that have hindered the mass adoption of digital music.

2) Another method is to use a conventional computer keyboard for inputting music notes. Because the alpha-numerical keyboard layout, designed for character input, is dramatically different from that of a musical instrument, a standard computer keyboard is extremely inconvenient to use for music input. Although several efforts have been made to improve this, they all prioritize character input over music input. Consequently, they are still very cumbersome to apply because they do not solve the fundamental problem resulting from the incompatible form factors between computer and musical keyboards. Among these approaches, U.S. Pat. Nos. 5,646,648, 6,066,795, and 6,351,225 propose to associate the music input functionality with a subset of keys on the standard computer keyboard. For example, U.S. Pat. Nos. 5,646,648 and 6,351,225 designated the top row of the standard keyboard to represent one octave of music notes. Limited by the standard layout of a computer keyboard, however, the range of notes offered by such approaches is very limited. U.S. Pat. No. 6,444,888 describes a method to define the relationship between key code and music notes such that it maps the most frequently used music notes to the most convenient keys. The drawback of this approach is twofold: (a) there is a big learning curve for using such a mapping and (b) it still relies on a standard computer keyboard, which has the inconvenient layout for music input.

3) The third method is to use a music keyboard adaptor on top of the computer keyboard. The music keyboard adaptor is a frame with piano-like keys. By pressing the keys on the frame, the keys underneath are instrumented. U.S. Pat. Nos. 4,352,313, 4,704,940, and 5,971,635 follow such a method. The disadvantage of this approach is that the two level of instrumentation adds annoying delays for music play back. Many standard keyboards also have clicking noise, affecting the sound effect. In addition, it is impossible to design a generic frame that fits the shape and size of an arbitrary computer keyboard.

### SUMMARY OF THE INVENTION

It is an object of the present invention to provide a computer music input system, and keyboard input apparatus with a plurality of functions.

It is another object of the present invention to provide a method of processing the input signals from a keyboard, which converts the keyboard signals into music signals to alleviate the hardware dependence on special-purpose MIDI devices in a computer music system, through the use of computer software.

According to one aspect of the present invention, it provides a computer music input system, comprising an input means having a music-input device composed of music-input keys and a character-input device composed of character-input keys for generating key codes corresponding to the pressed music-input or character-input keys; a music processing means for establishing the mapping table between key codes and music notes, receiving the key codes generated by said input means and converting the key codes into special notes, and generating digital sound signals for the intended note; and an output means having a computer sound card and the associated output device (such as a speaker or a headphone) for converting the digital sound signals generated by said music processing means into analog signals and playing back the input music.

According to another aspect of the present invention, it provides a keyboard input apparatus for a computer music input system. The apparatus comprises a music-input device having a plurality of music-input keys; a character-input device having a plurality of character-input keys; and a digital circuit comprising a matrix of switches for generating key codes in response to the press of external keys on the keyboard input apparatus, and outputting the key codes to the computer.

According to yet another aspect of the present invention, it provides a method of processing music signals in computer music input system, comprising the steps of: setting up the mapping between key codes and music notes to establish a key-to-note mapping table and storing said mapping table in the computer; monitoring key interrupt events generated by a keyboard input apparatus, identifying the corresponding note according to said key-to-note mapping table; synthesizing the digital signal of the sound that emulates the tone of the note being played; and converting digital signal to analog signal for play back.

The present invention provides an inexpensive solution that solves the music input inconvenience caused by traditional character-oriented keyboard layout. This is achieved through the combination of a low cost and effective input apparatus, and the power of computer software. In comparison with special-purpose MIDI keyboards, the present invention applies the music processing program to facilitate music input. Therefore, it eliminates the dependence on expensive MIDI hardware and avoids the complex setup process for MIDI systems. Comparing to standard computer keyboards or music keyboard adaptors, this invention dramatically enhances the convenience for music input. With our approach, the music-input component is relatively independent of the character-input component. As a result, the layout of music keys is not limited by the standard keyboard format, and music input and character input do not interfere with each other. Because the music-input component resembles musical keyboard instruments, music input can be performed in a natural and convenient way. Combined with suitable software applications, the music input system of the present invention can be applied for music education, music editing, and family entertainment.

### BRIEF DESCRIPTION OF THE DRAWINGS

Above and other objects and advantages of the present invention will become apparent and more readily appreciated from the following description of the embodiments, taken in conjunction with the accompany drawings. It should be noted that the invention is not limited to these embodiments.

FIG. 1 is a block diagram showing a conventional MIDI digital music system;

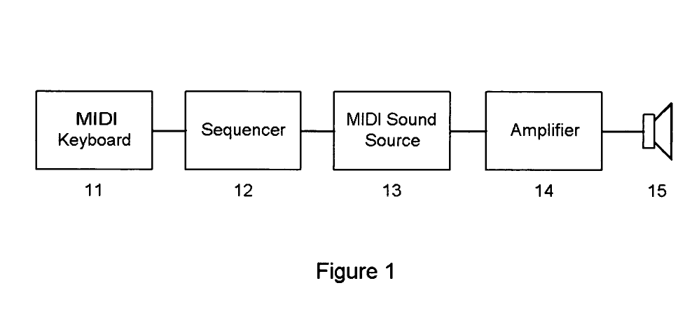

FIG. 2 is a block diagram showing the computer music input system according to an embodiment of the present invention;

FIG. 3 is a flow chart explaining the music signal processing according to an embodiment of the invention;

FIG. 4 is a view showing the configuration of the input apparatus according to an embodiment, wherein the music-input component and the character-input component are separate units and are connected in serial to the computer.

FIG. 5 is a view showing the configuration of the input apparatus according to another embodiment, wherein the music-input component and the character-input component are located on the same side of a single unit. Furthermore, the input apparatus further comprises a pedal connected by a cable; and

FIG. 6 is a view showing the configuration of the input apparatus according to yet another embodiment, wherein the music-input component and the character-input component are located on the opposite sides of a single unit.

### DETAILED DESCRIPTION OF THE PREFERRED EMBODIMENTS

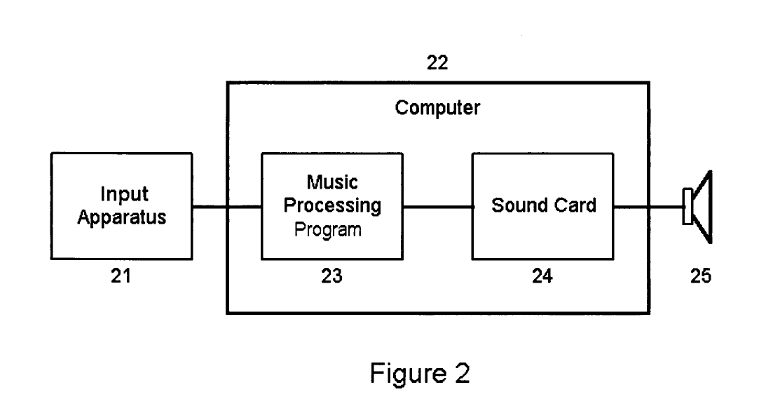

Referring to FIG.2, the computer music input system of the present invention comprises a multifunctional input apparatus 21, a music processing unit 23 which may be, for example, a program running on a computer, and a sound card 24, which is connected to an output device 25 such as a speaker or an ear phone. The input apparatus 21, consisting of a set of keys and a control circuit (not shown in the figure), applies techniques similar to that of standard computer keyboards. The control circuit has a matrix of switches (not shown in the figure) for monitoring whether the outside keys are pressed or released. The control circuit scans the switch-matrix, filters out the jittering effect, and produces the corresponding key codes when key activities are detected. Such key codes are subsequently sent to the computer. (The communication mechanism between the keyboard and the computer is out of the scope of this invention.) The primary difference between the input apparatus 21 and a standard computer keyboard is that the input apparatus 21 also includes a music-input component in addition to the character-input component. The music-input component consists of piano-like music keys for inputting music notes. The music-input component and the character-input component are relatively independent. Therefore, the input apparatus conveniently supports the dual-capability for both music and character input purposes. In this invention, each music key can share the same key code with a character key. Therefore, increasing the number of music keys does not require sacrificing the number of character keys. There are 88 keys on a standard piano. The number of key codes supported by typical computer keyboards far exceeds 88. Therefore, the input apparatus can provide enough octaves of music notes according to a user's need.

If the music processing program 23 is not started, any input from the input apparatus is treated as standard character input. If music input is needed, the music processing program 23 needs to be started—it “knows” how to interpret the key codes received from the input apparatus. When a key is pressed, the corresponding key code is sent to the computer. Upon receiving the key code, the controller (not shown in the figure) in the computer 22 generates an interrupt request that is handled by the interrupt service program. The interrupt service program passes the keyboard interrupt event and the corresponding key code to the music processing program 23. The music processing program 23 can exist either as part of the operating system or as an application program. Program 23 monitors the keyboard interrupt events generated by the input apparatus. In particular, it handles the “key-pressed” and “key-released” events. It transforms the key events into musical events, emulates the sound effect through sound synthesis, and passes the sampling data to the device driver of the sound card 24. The sound card 24 then transforms the digital data to analog data and plays it back through the output device 25.

Now the detailed method of processing music signals is explained. Because the signals generated by the input apparatus 21 are only standard key codes, they need to be interpreted by the music processing program 23. It should be noted that the music processing unit 23 can be implemented by hardware or software independently, or by the combination of hardware or software.

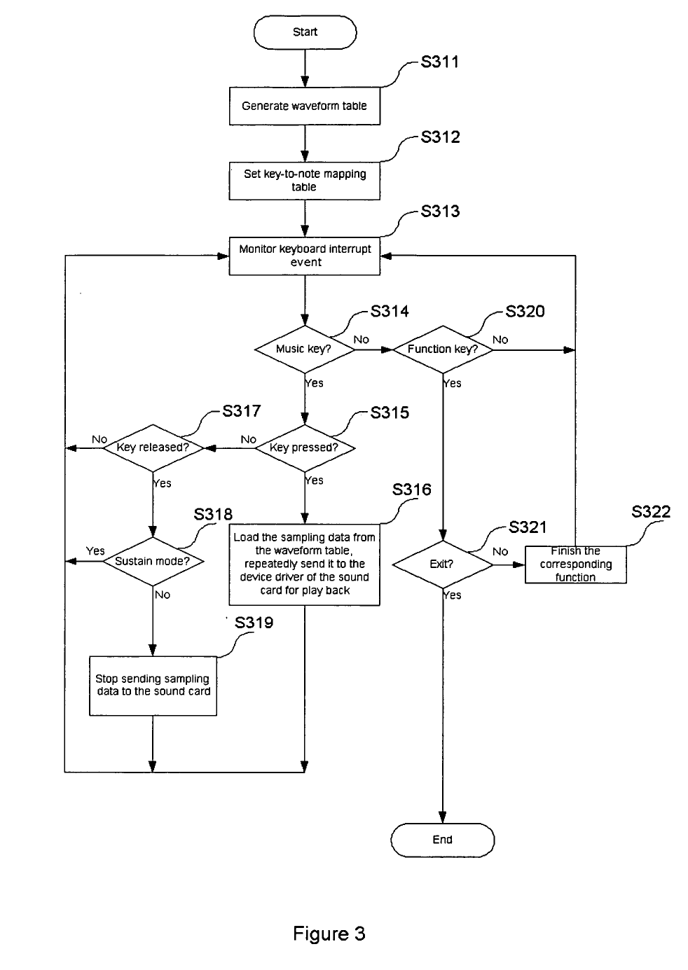

FIG. 3 illustrates the flow chart of the processing method. First, the waveform table needs to be established (step S311). Then, the mapping between the keys and music notes is setup in a key-to-note mapping table and stored in memory or hard disk (step S312). Some keys can be assigned with special functionalities, such as exiting the music processing program, and adjusting volume, scale, or the sustain mode. The definitions of these special keys are also setup.

In step S313, the processing program monitors the keyboard event in real-time. After retrieving the key code from an interrupt event, the program consults the mapping table and determines whether that key represents a music note. If the key does not represent a music note, the flow proceeds to step S320 to determine whether the key has any special functionality. If the key has a special functionality, the processing program performs the intended function in step S322 and repeats the monitoring loop starting at S313.

If the key is detected to represent a music note (step S314 is positive), the flow proceeds to step S315 to determine if the event is “key-pressed”. If so, step S316 is taken for loading sampling waveform data (details will be elaborated later). If the result in step S315 is false, step S317 is taken to determine whether the event is “key-released”. If so, the process proceeds to step S318 to determine if the sustain mode is on. If so, the process repeats the monitoring loop starting at S313. Otherwise, step S319 is taken and the processing program stops feeding sound data to the sound card.

In the above process, if the received event is “key-pressed” and the key represents a music note, the music processing program generates a “Music Start” event. If the received event is “key-released”, the processing program generates a “Music Stop” event. If the key represents a special function key, the processing program 23 performs the function accordingly. The processing program 23 may perform additional tasks according to the intended need, e.g., editing, displaying notes on the screen, or playing back the music.

The process of generating the digital signal of a music note (step S316 in FIG. 3) is described as follows. To play back the music, the processing program needs to generate the corresponding digital signal for the music note. One method of this invention is to combine the information obtained from the input apparatus and waveform synthesis technique to produce the digital signal. For any sound, its signal can be represented by its waveform. For example, y=sin(x) is one of the simplest waveforms. Waveforms that simulate real musical instrument, however, is more complex and is usually composed of many different harmonic waves. The sound samples for a particular musical instrument can be recorded in advance, resulting an analog (continuous) waveform. A fragment (e.g., half a second) of such a waveform is captured and sampled at a certain interval according to the sampling rate. This results in a digital waveform, which can be stored in advance in RAM, ROM, or hard disk. Digital signals can be stored in various formats, e.g. PCM (Pulse Code Modulation). When the processing program receives the “Music Start” event, it loads the sampling data from the waveform table, and repeatedly feed the data to the sound card based on the pitch and duration of the note. In addition, it gradually decreases the volume of the sound, emulating the natural dissipating effect. When the event of “Music Stop” is received, the program stops feeding data to the sound card to stop the play back.

In addition to the sampling method, waveform table can also be calculated following certain algorithms. This can be done either in advance or in real-time. Common algorithms include FM Frequency Modulation, Subtractive Simulation Synthesis, or Linear Arithmetic Synthesis. In comparison with the sampling method, the real-time synthesis approach can save storage space and can generate flexible tones but it imposes a higher computational demand.

Another method of the present invention is to integrate standard computer keyboard input techniques with the MIDI technology as follows: The music processing program handles the keyboard interrupt event, and generates the corresponding MIDI message when receiving a musical event. When “key-pressed” is detected for a key representing a music note, the music processing program immediately creates a “Note On” MIDI message. When “key-released” is detected for a key representing a music note and the sustain mode is off, the music processing program immediately generates a “Note On” MIDI message with the velocity value set as 0. The MIDI message is passed to the software or hardware components that support the MIDI protocol to complete the sound play back. The advantage of this method is that the processing program can be compatible with other application software that supports MIDI. The disadvantage is that going through various layers of the MIDI protocol might increase the delay time for play back.

Multifunction Input Apparatus

A novel input apparatus is applied in the present invention to make music input more convenient. In order to lower the cost, the input apparatus is designed to complete music input without resorting to special MIDI hardware.

Similar to the technology used in a standard computer keyboard, the input apparatus of the invention uses the underlying control circuit to monitor the status of the keys. In contrast to a standard computer keyboard, however, the input apparatus comprises two components, one for music input and the other for character input. The music-input component consists of a set of piano-like keys; it may further comprise special function keys to configure preferable settings. The character-input component has a layout similar to that of a traditional computer keyboard. One characteristic of the input apparatus is that music keys and character keys can share key codes. Not only does this simplifies the design of the underlying circuit, it also eliminates the constraint on the total number of notes, which is imposed by some existing solutions in which key codes cannot be shared between music and character keys.

The two components of the input apparatus can be connected using different configurations. While applying the same technology and providing the same functionality, the configuration flexibility allows users to choose the most desirable way to assemble the input device according to their specific needs.

One configuration embodiment of the input apparatus is that the two components are separate modules; each has its individual keys and control circuit. They are connected in serial through cables or sockets. This configuration is space-saving since the music-input module only needs to be hooked up as needed.

Another embodiment of the input apparatus is that the two components are separate modules; each has its individual keys and control circuit. Instead of being connected in serial, the two components are connected in parallel, i.e., they are independently connected to the computer.

Yet another embodiment of the input apparatus is that the two components are built into a single unit, sharing the same control circuit and communication interface with the computer. To save space, the music-input component and the character-input component are located on the opposite sides of the keyboard. When a different input mode is needed, the user simply needs to turn the keyboard up side down.

Further another embodiment of the input apparatus is that the two components are built into a single unit, sharing the same control circuit and communication interface with the computer. In contrary to the double-sided configuration, all keys are located on the same side of the keyboard.

In order to allow the input apparatus to be used even without a computer, an embodiment of the input apparatus may further comprise a sound synthesizer, which is connected to the control circuit of the input device so that sound can be produced directly when a music key is pressed. An embodiment of the input apparatus may further comprise a pedal module to emulate the sustain effect or mute effect of a piano. An embodiment of the input apparatus may also comprise a velocity-detection device to make the keys force-sensitive.

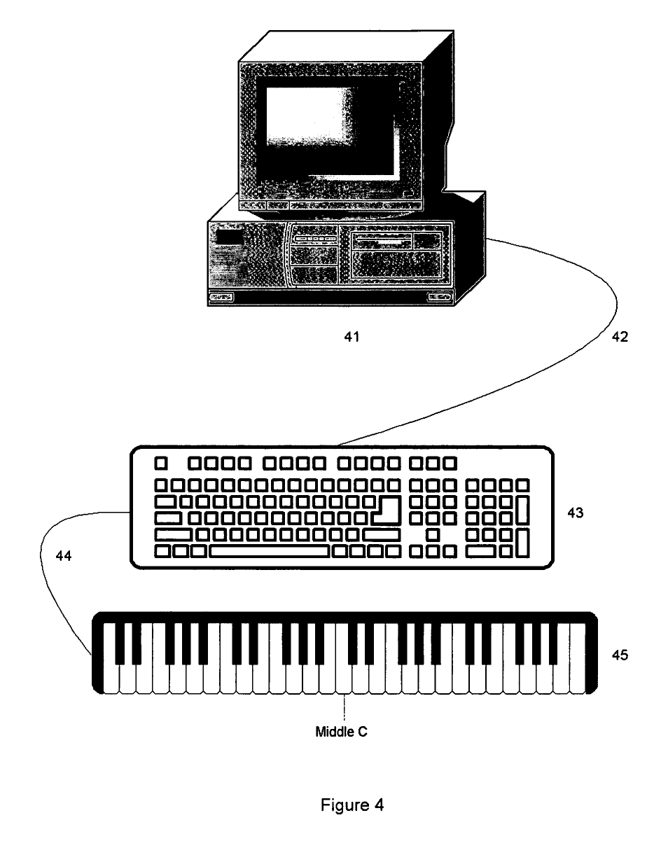

FIG. 4 shows one embodiment of the input apparatus, which employs a configuration that has separate and serially connected modules. The input device comprises the character-input component 43 and the music-input component 45. A wire 42 connects the character-input component 43 and the computer 41. While having the same format as a standard keyboard, the character-input component 43 also has a wire 44 that connects to the music-input component 45. The music-input component consists of 49 music keys, with the size and color similar to that of piano keys. Music keys represent different notes. For example, if the music key of “Middle C” is defined to correspond to alphabet “A”, pressing “Middle C” will generate the same key code as pressing “A”. Although the input device only generates standard key codes, the music processing program can process it properly according to the key-to-note mapping table. Polyphony is supported since standard keyboards allow simultaneous pressing of multiple keys. One caveat, however, is that special control keys should be avoided while defining the key-to-note mapping. For instance, the Windows operating system would be restarted by simultaneously pressing Ctrl-Alt-Delete. It is therefore not appropriate to assign these keys to represent music notes. Because the music-input component is serially connected, it can be unplugged when not used, in which case the input device would become a standard alpha-numeric keyboard. When music input is needed, a user simply needs to connect the music-input device and start the music processing program. Because the size and format of the music-input component is independent of the character-input component, it can be built exactly the same as a musical instrument.

This particular embodiment samples the sound of a grand piano using 16 Bit data and a sampling rate of 44.1 KHz. It then captures a 0.5 second fragment of the waveform and stores it in a waveform table in hard disk. The music processing program is implemented in a programming language, e.g., C++. When started, it initializes the key-to-note mapping table, and enters a loop for handling the “key-pressed” and “key-released” interrupt events. For any key corresponding to a music note, the processing program converts the keyboard interrupt event to a “Music Start” event and starts to feed the sampling signal to the sound card for play back. In the mean time, it displays the musical event on screen through a graphical user interface (GUI). This embodiment also applies some function keys to control user settings. For example, F1 is used to exit the program; F2 is used to toggle the sustain mode; F3 and F4 are respectively used to increase and to decrease the volume; F5 and F6 are respectively used to increase and to decrease the octave range. If the “key-released” signal is received for a key representing a music note while the sustain mode is off, a “Music Off” event is generated to stop the play back. By default, most computer keyboards have a feature to repeatedly generate key codes if a key is held down. Although useful for character input, this would be an annoying side effect for music input. To solve this problem, the status of key releases is tracked in the music processing program. The program checks whether the key has been released when the “key-pressed” event is received. The event is caused by automatic key code generation and can be ignored if the key has not been recently released.

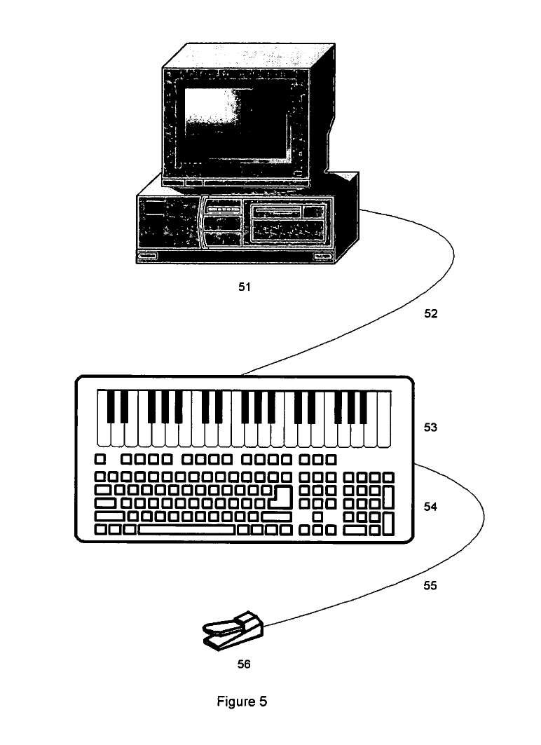

FIG. 5 shows another embodiment of the input apparatus of the present invention, which employs a single-unit, single-sided configuration. This embodiment adopts a processing program similar to the above one, but the sound data is synthesized in real-time using a simple harmonic wave: y=sin(x)+sin(2*x)/2+sin(4*x)/4. It also provides a user interface to allow the user to enter a preferred wave formula. As shown in FIG. 5, the music-input component 53 and the character-input component 54 are located on the same side of a single module; they are connected to a pedal module 56 via a cable 55. Pressing the pedal causes the sustain effect. The input apparatus is connected with the computer 51 through a PS/2 cable 52.

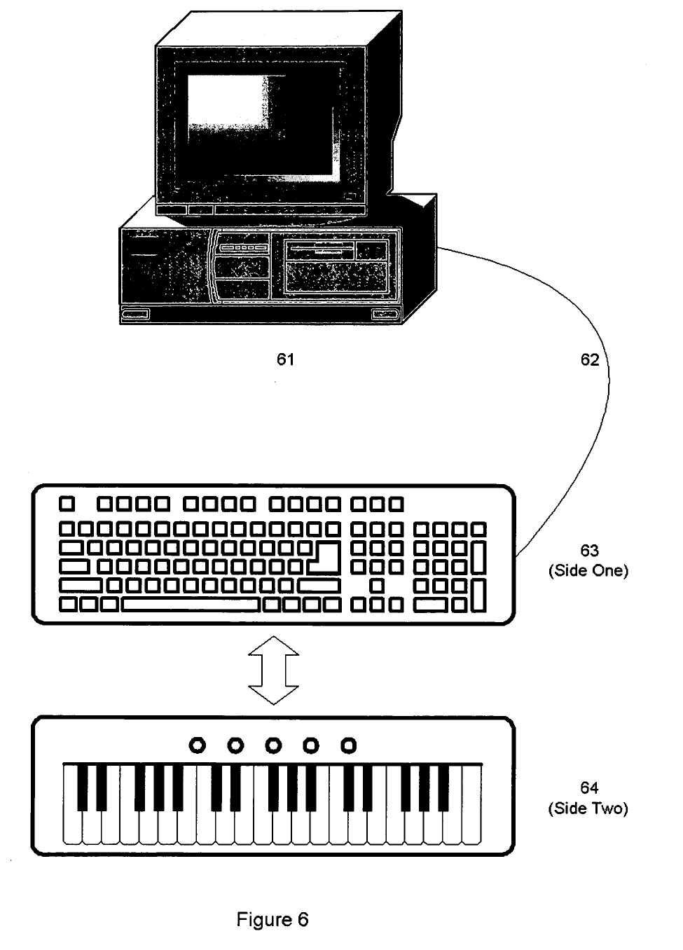

FIG. 6 illustrates another embodiment of the input apparatus. The character-input component 63 and the music-input component 64 are distributed on the opposite sides of the device. The music-input component includes 37 music keys and 5 function keys. The 5 function keys are used to configure volume, scale, and the sustain mode. The two components share a cable 62 to connect to the computer 61. The music processing software is written in a programming language, e.g., Java. Keyboard interrupt events are handled through the keyPressed and keyReleased methods. Upon receiving the “Music On” event, the processing software generates a “Note On” MIDI message. The velocity field is set according to the system setting. Then the library “javax.sound.midi” is called to send out the MIDI message. Upon receiving the “Music Off” event, the software sends out a “Note On” MIDI message with a velocity field of 0 using the “javax.sound.midi” library.

Although the present invention has been described by way of exemplary embodiments, it should be understood that many changes and substitutions may further be made by those skilled in the art without departing from the spirit and scope of the present invention which is defined by the appended claims.

1. A computer music input system, comprising
an input means having a music-input device composed of a plurality of music-input keys and a character-input device composed of a plurality of character-input keys for generating key codes corresponding to the pressed music-input or character-input keys;
a music processing means for establishing the mapping table between key codes and music notes, receiving the key codes generated by said input means and converting the key codes into special notes, and generating digital sound signals for the intended note; and
an output means for converting the digital sound signals generated by said music processing means into analog signals and playing back the input music.

2. A keyboard input apparatus for inputting music notes into a computer system, comprising
a music-input device having a plurality of music-input keys;
a character-input device having a plurality of character-input keys; and
a digital circuit comprising a matrix of switches for generating key codes in response to the press of external keys on the keyboard input apparatus, and outputting the key codes to the computer.

3. The keyboard input apparatus according to claim 2, wherein said music-input device and said character-input device are separate units comprising individual keys and control circuit, and are connected to the computer in a serial or parallel manner.

4. The keyboard input apparatus according to claim 2, wherein said music-input device and said character-input device are located on opposite surfaces of a single unit, sharing a common control circuit for connecting to the computer.

5. The keyboard input apparatus according to claim 2, wherein said music-input device and said character-input device are located on the same surface of a single unit, sharing a common control circuit for connecting to the computer.

6. The keyboard input apparatus according to claim 2, wherein the input apparatus further comprises a sound synthesizer, which plays back the sound when a key is pressed.

7. The keyboard input apparatus according to claim 2, wherein the input apparatus further comprises a electrically-connected pedal, for achieving special effects such as the sustain effect or the mute effect.

8. The keyboard input apparatus according to claim 2, wherein the keys in the music-input device further comprise devices for simulating resistance of the key according to the force applied.

9. The keyboard input apparatus according to claim 3, wherein the keys in the music-input device further comprise devices for simulating resistance of the key according to the force applied.

10. The keyboard input apparatus according to claim 4, wherein the keys in the music-input device further comprise devices for simulating resistance of the key according to the force applied.

11. The keyboard input apparatus according to claim 5, wherein the keys in the music-input device further comprise devices for simulating resistance of the key according to the force applied.

12. The keyboard input apparatus according to claim 6, wherein the keys in the music-input device further comprise devices for simulating resistance of the key according to the force applied.

13. The keyboard input apparatus according to claim 7, wherein the keys in the music-input device further comprise devices for simulating resistance of the key according to the force applied.

14. The keyboard input apparatus according to claim 2, wherein the music-input device further comprises function keys for configuring play back settings, such as sound volume, sound tone, and sustain mode.

15. The keyboard input apparatus according to claim 3, wherein the music-input device further comprises function keys for configuring play back settings, such as sound volume, sound tone, and sustain mode.

16. The keyboard input apparatus according to claim 4, wherein the music-input device further comprises function keys for configuring play back settings, such as sound volume, sound tone, and sustain mode.

17. The keyboard input apparatus according to claim 5, wherein the music-input device further comprises function keys for configuring play back settings, such as sound volume, sound tone, and sustain mode.

18. The keyboard input apparatus according to claim 6, wherein the music-input device further comprises function keys for configuring play back settings, such as sound volume, sound tone, and sustain mode.

19. The keyboard input apparatus according to claim 7, wherein the music-input device further comprises function keys for configuring play back settings, such as sound volume, sound tone, and sustain mode.

20. A method of processing music signals in computer music input system, comprising the steps of:
setting up the mapping between key codes and music notes to establish a key-to-note mapping table and storing said mapping table in the computer;
monitoring key interrupt events generated by a keyboard input apparatus, generating the key codes corresponding to said key interrupt events, and identifying the corresponding note according to said key-to-note mapping table;
synthesizing the digital signal of the sound that emulates the tone of the note being played; and
converting digital signal to analog signal for playing back.

21. The method according to claim 20 further comprising an initial step of generating the waveforms according to the tone of a certain instrument either by sound sampling or by using a sound synthesis algorithm, and subsequently generating the digital waveform table by sampling the data according to certain frequency.

22. The method according to claim 20 further comprising a step of repeatedly playing back the sample fragment of the waveform using a certain frequency according to the pitch and duration of a note, after retrieving the event information from the “key-pressed” interrupts.

23. The method according to claim 22 further comprising a step of selecting the sustain mode such that if the sustain mode is on, the note is continuously played upon receiving a “key-pressed” event and is stopped immediately after receiving a “key-released” event; if the sustain mode is off, said note is played back in gradually decreasing the volume to simulate the natural dissipating effect.

24. The method according to claim 20 further comprising a step of generating the corresponding “Note On” MIDI message upon receiving the “key-pressed” event and sending the signal to device drivers that support the MIDI protocol, if a sustain mode is set, sending a “Note On” MIDI signal with the “velocity” field to be 0 after “key-released” is detected.
